(19) United States
(12) Patent Application Publication
(10) Pub. No.: US 2008/0202894 A1
(43) Pub. Date: Aug. 28, 2008

(54) MISALIGNED ARTICLE DISENGAGEMENT SYSTEM FOR A DISC SINGULATOR

(76) Inventor: Real PERREAULT, Saint-Augustin-de-Desmaures (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/680,206

(22) Filed: Feb. 28, 2007

(51) Int. Cl. B65G 43/08; B07C 5/02

(52) U.S. Cl. 198/395; 209/539

(57) ABSTRACT

The disengagement system is for use at an output of a centrifugal disc singulator in which elongated articles exit lengthwise following a substantially tangential output path at a periphery of a rotary disc. The rotary disc has a vertical rotation axis and an upper article-receiving area surrounded by a peripheral wall. The disengagement system comprises a lateral conveyor positioned at a radially-outer side of the output, and a vertically-extending fulcrum member positioned at a radially-inner side of the output. In use, a misaligned article is moved out of the output by the disengagement system and back to the article-receiving area.

### BACKGROUND

Centrifugal disc singulators, sometimes referred to as rotary disc feeders, are machines used for automatically orienting and aligning articles from a disorderly bulk supply into a single row or file. Examples of these machines are described, for instance, in U.S. Pat. Nos. 3,224,554 and 5,044,487. Typically, they include a rotating disc which receives the articles to be aligned in bulk and moves them toward an output by displacing them radially outwardly due to centrifugal force.

Although most existing disc singulators have been found satisfactory to a certain degree, room for further improvements always exist. For example, some of the articles to be aligned may nevertheless proceed through the output while still being misaligned, and then block the output at one point. A manual intervention and complete stop of the machine is sometimes required to remove such blockages, which results in undesirable down time for the machine. This is particularly true in the case of elongated articles.

A system which allowed to alleviate some of these difficulties was presented by Assignee in corresponding published US patent application No. 2006/0243561 filed on Apr. 25, 2005 and entitled “ARTICLE FEEDER AND SPACER”. The system includes a sensor to detect the presence of a misaligned article, and an arm which is activated to dislodge the misaligned article upon detection. Further improvements were still desirable.

### SUMMARY

In accordance with one aspect, there is provided a misaligned article disengagement system for use at an output of a centrifugal disc singulator in which elongated articles exit lengthwise following a substantially tangential output path at a periphery of a rotary disc, the rotary disc having a vertical rotation axis and an upper article-receiving area surrounded by a peripheral wall, the disengagement system comprising: a lateral conveyor positioned at a radially-outer side of the output, the lateral conveyor having an inner portion extending substantially parallel to the output path and movable in a direction opposite the output path; and a vertically-extending fulcrum member positioned at a radially-inner side of the output and being adjacent to the inner portion of the lateral conveyor; whereby, in use, a misaligned article is moved out of the output and back to the article-receiving area of the singulator when a leading end of the misaligned article engages the inner portion of the lateral conveyor and a side of the misaligned article engages the fulcrum member.

In accordance with an other aspect, there is provided a centrifugal disc singulator comprising: a rotary disc having a vertical rotation axis and defining an upper article-receiving area surrounded by a peripheral wall and an output in which elongated articles exit lengthwise following a substantially tangential output path at a periphery of the rotary disc, a lateral conveyor positioned at a radially-outer side of the output, the lateral conveyor having an inner portion extending substantially parallel to the output path and movable in a direction opposite the output path, and a vertically-extending fulcrum member positioned at a radially-inner side of the output and being adjacent to the inner portion of the lateral conveyor.

In accordance with an other aspect, there is provided a method of disengaging a misaligned article entering an output of a centrifugal disc singulator having an upper article-receiving area, the method comprising: moving a leading end of a misaligned article abutting a radially-outer side of the output, the leading end being moved in a direction opposite an output path; and supporting the side of the misaligned article along a vertically extending fulcrum member positioned at a radially-inner side of the output until the misaligned article goes back into the article-receiving area.

### DESCRIPTION OF THE FIGURES

Further features and advantages of the present improved misaligned article disengagement system will become apparent from the following detailed description, taken in combination with the appended figures, in which:

FIG. 1 is a perspective view of an example of a disc singulator with an example of the improved misaligned article disengagement system;

FIG. 2 is a top plan view of the disc singulator shown in FIG. 1;

FIG. 3 is an enlarged top plan view showing some of the parts at the output of the disc singulator of FIG. 1;

FIG. 4 is an isometric view showing the misaligned article disengagement system of FIG. 1;

FIG. 5 is an isometric view of the lateral conveyor used in the misaligned article disengagement system shown in FIG. 4;

FIG. 6 is a view similar to FIG. 5, showing the lateral conveyor from an opposite side;

FIG. 7 is cross-sectional view taken along line 7-7 of FIG. 2;

FIG. 8 is a cross-sectional view taken along line 8-8 of FIG. 2;

FIG. 9 is a cross-sectional view taken along line 9-9 of FIG. 2;

FIGS. 10 to 13 are schematic top plan views successively depicting an example of the disengagement of a misaligned article in the disengagement system of FIG. 1.

### DETAILED DESCRIPTION

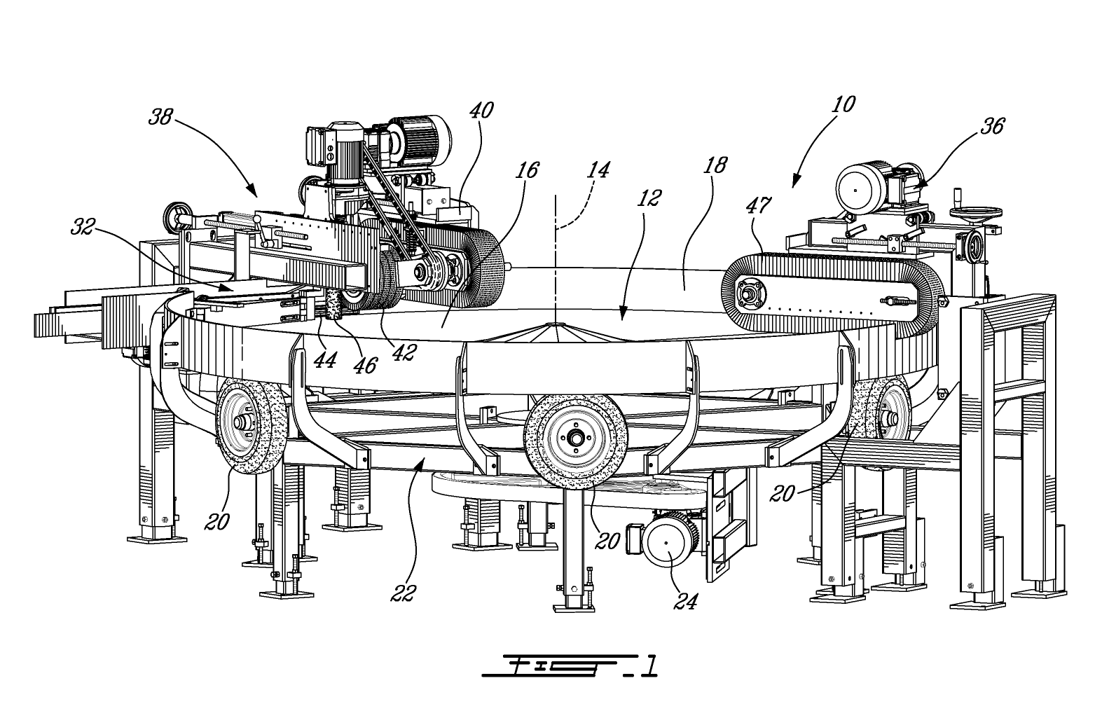

FIG. 1 shows an example of a centrifugal disc singulator 10. The disc singulator 10 includes a rotary disc 12 having a vertical rotation axis 14 and defining an upper article receiving area 16 surrounded by a peripheral wall 18. The rotary disc 12 is supported by a plurality of spaced-apart support wheels 20 which are rotatably mounted to a frame 22. A rotary disc motor 24 is provided to drive the rotary disc 12 into rotation. In the illustrated example, the rotation of the disc 12 is in a counter-clockwise direction when viewed from above. The peripheral wall 18 is also mounted to the frame 22.

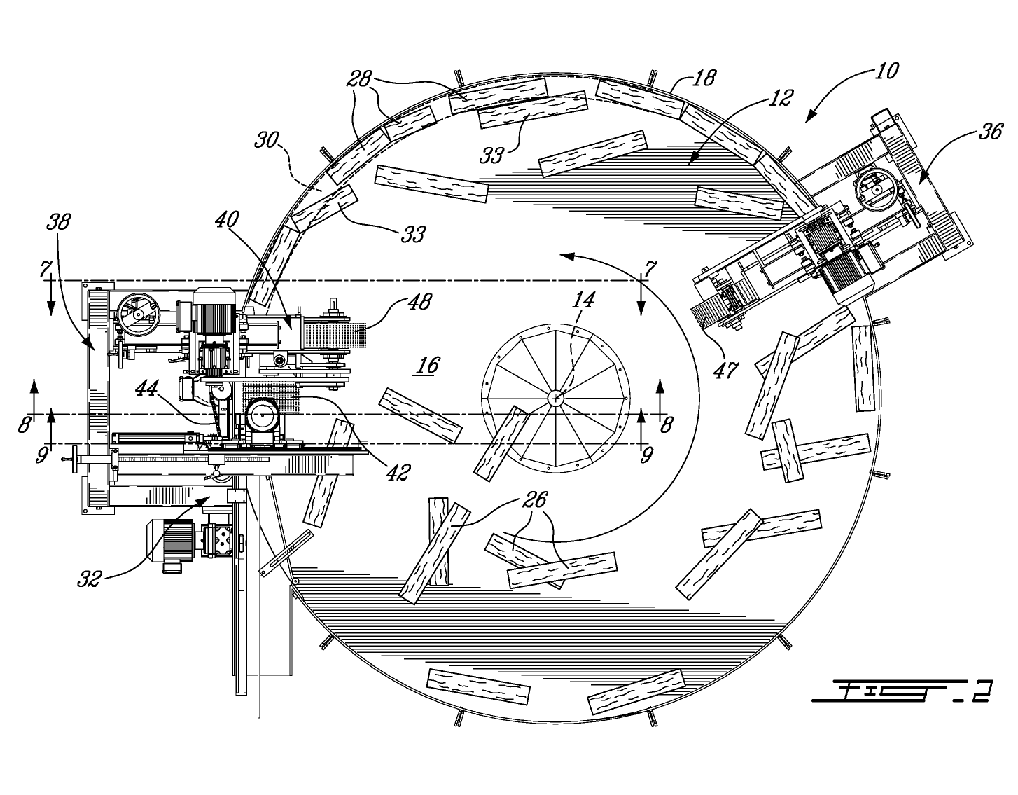

FIG. 2 shows the disc singulator in operation once a bulk supply of wood board pieces 26 having various lengths is dropped onto the article receiving area 16. The rotation of the disc 12 displaces the wood board pieces 26 toward the peripheral wall 18 due to centrifugal force. During this displacement, stacks of wood board pieces 26 from the bulk supply progressively disaggregate, and wood board pieces laying on a side tend to fall and lay flat against the upper surface of the disc 12. Some of the wood board pieces 26 soon become longitudinally aligned against the peripheral wall 18. However, some wood board pieces 26 can remain in a stacked configuration abutting the peripheral wall, and some wood board pieces 26 can laterally abut against other wood board pieces 26 and thus be maintained in a misaligned state. Such misaligned wood board pieces are not longitudinally aligned against the peripheral wall 18 and laying flat against the upper surface of the rotary disc 12. Because of the rotation of the disc 12, correctly aligned articles 28 follow a tangential output path 30 and lengthwisely engage an output 32 of the disc singulator 10. The disc singulator 10 is designed to allow them to exit through the output 32. The function of the disc singulator 10 is thus to orient and arrange the bulk supply of wood board pieces 26 so as to create an orderly file of wood board pieces out the output 32.

Misaligned wood board pieces 33 can lead to blockage at the output 32. Accordingly, the disc singulator 10 has a plurality of features to reduce the risks of having the output blocked, including a misaligned article disengagement system 38 (on the left-hand side of the figure) provided to move misaligned articles engaging the output 32 back to the article receiving area 16. Articles that are moved out of the output 32 will be correctly aligned at a later time. The aim of the misaligned article disengagement system 38 is to remove and disengage all the wood board pieces which are not correctly aligned lengthwise along the peripheral wall 18 from the output 32, and to move them back to the article receiving area 16 of the disc 12.

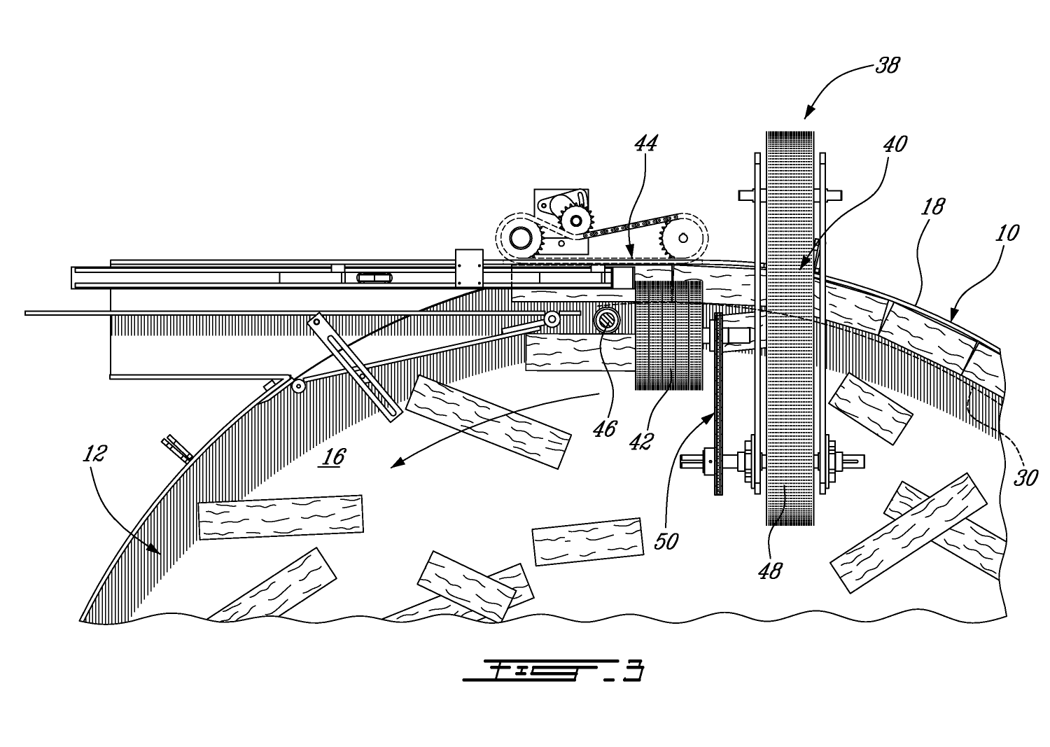

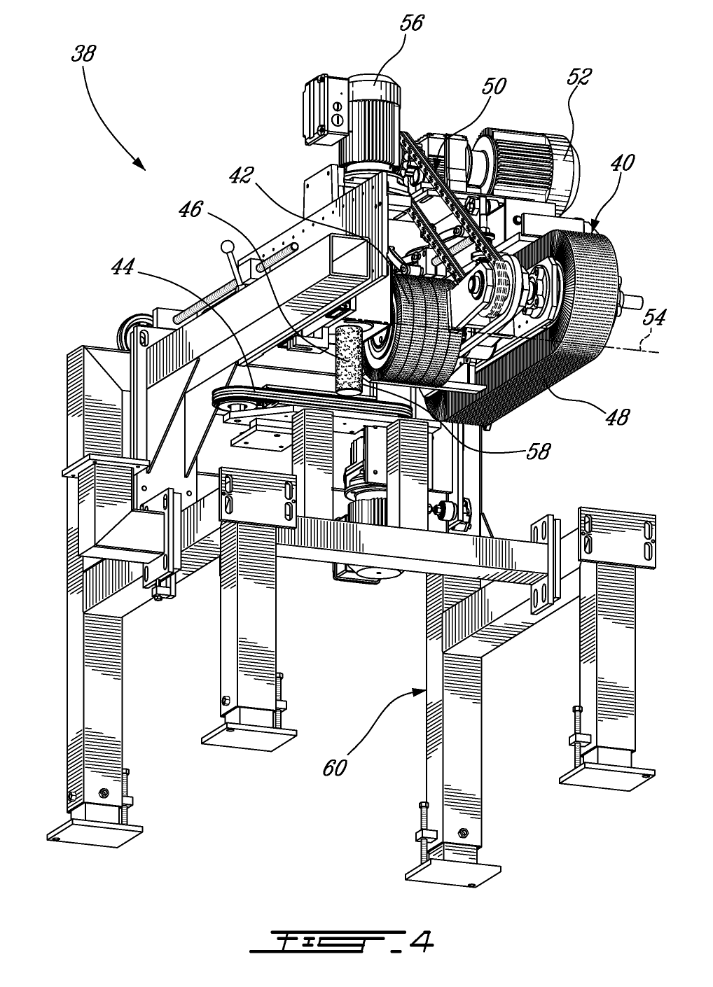

In the illustrated example, the misaligned article disengagement system 38 has a round brush 42, a lateral conveyor 44 and a vertically extending roller 46 (FIG. 1). The lateral conveyor 44 is positioned on a radially outer side of the output 32, whereas the roller 46 is positioned on a radially inner side of the output 32, relative to the rotation axis 14 of the disc 12. Reference to FIGS. 3 and 4 can be made for greater clarity.

The illustrated misaligned article disengagement system 38 also includes a first pile breaker 36 (on the right hand side of the figure), and a second pile breaker 40 (on the left hand side of the figure), provided upstream of the output to move superposed articles back toward the center of the disc 12. The first pile breaker 36 and the second pile breaker 40 each include a respective conveyor brush 47, 48 which has a lower portion moveable toward the disc rotation axis. Each conveyor brush 47, 48 is driven by a corresponding conveyor brush motor via a conveyor brush driving mechanism.

As shown in FIG. 4, in the illustrated example, the round brush 42 is connected to the driving mechanism 50 of the conveyor brush 48 of the second pile breaker 40, and is also driven by the conveyor brush motor 52. The axis of rotation 54 of the round brush 42 is substantially horizontal, and parallel to the output path 30 (FIG. 2). The vertically extending roller 46 is driven by a roller motor 56. The roller 46 has a frictional outer surface 58. The round brush 42, lateral conveyor 44, and roller 46 are all mounted onto an auxiliary frame 60, and the auxiliary frame 60 is mounted onto the frame 22 of the disc singulator 10 (FIG. 1).

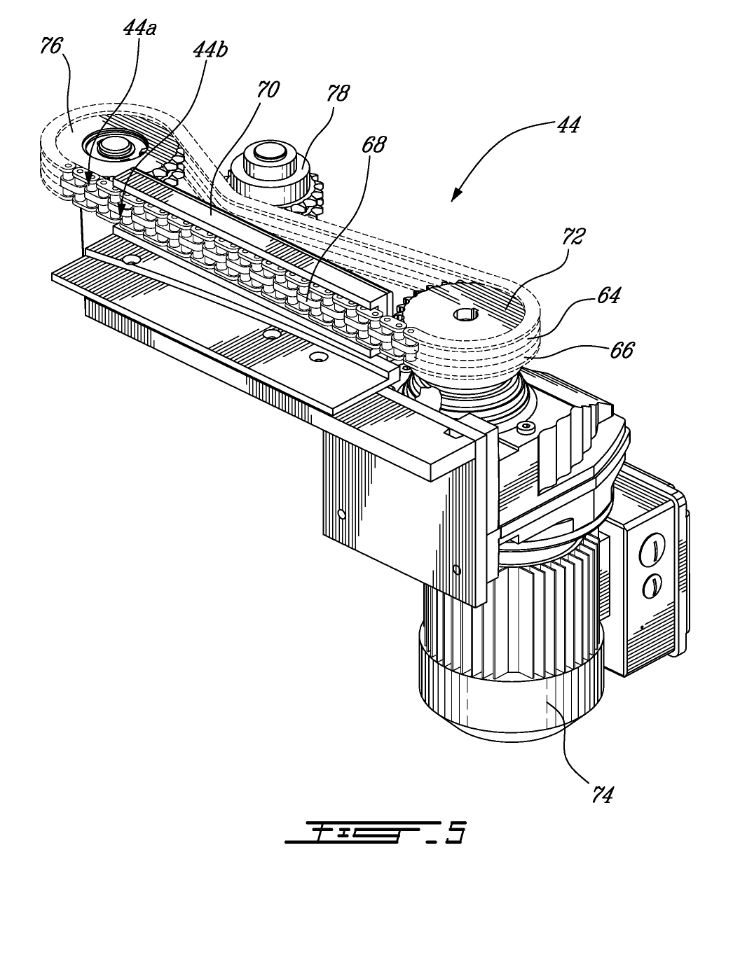

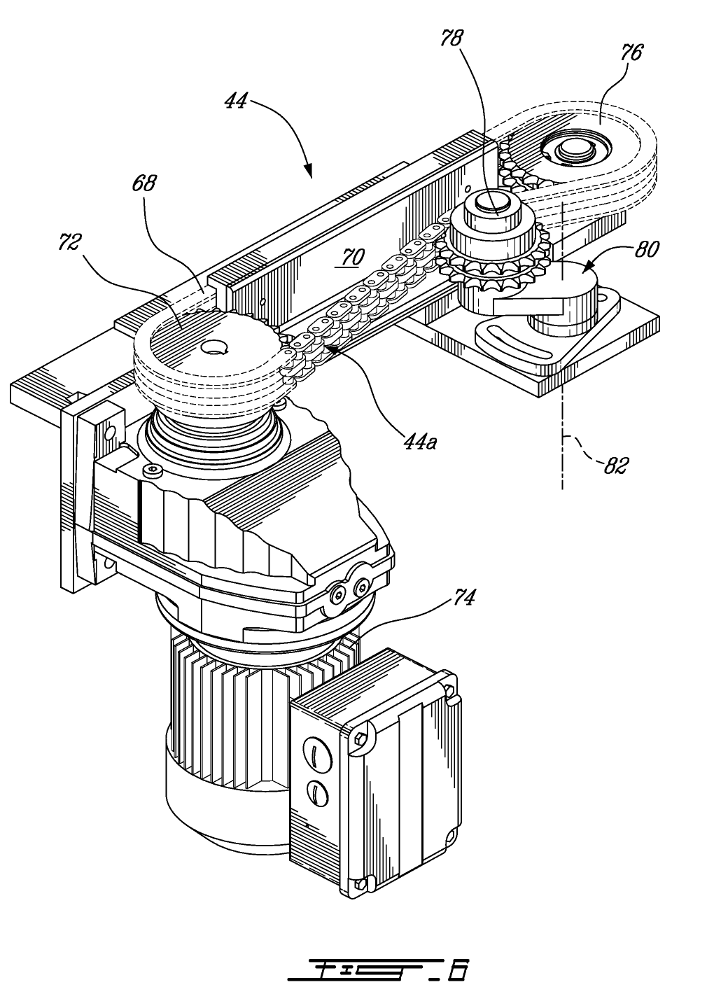

The lateral conveyor 44 is depicted in greater detail in FIGS. 5 and 6. In this case, the lateral conveyor 44 is an endless chain 44a, and more particularly, a double width chain 44b driven by a chain motor 74. The chain 44a is of double width in the sense that it includes first and second adjacent chains 64, 66, thus totaling a double width. In alternate embodiments, the width of the chain 44a can be varied by using one or more than two adjacent chains and by varying their widths.

The radially-inner portion 68 of the chain 44a (relative to the rotation axis of the rotary disc) is backed by a backing plate 70 which is fixed. The chain 44a is slidingly engaged within the backing plate 70. Hence if a misaligned article impacts the inner portion 68 of the chain 44a with force, the impact will be absorbed at least partially by the backing plate 70 rather than by an increase in tension within the chain 44a.

The endless chain 44a is mounted onto two sprockets: a drive sprocket 72 connected to the chain motor 74, and an idle sprocket 76. A tension adjustment sprocket 78 is also used to allow adjusting the tension in the chain 44a. As can be seen in FIG. 6, the tension adjustment sprocket 78 is mounted to the frame via a tension adjustment mechanism 80 which allows a technician to pivot the tension adjustment sprocket 78 around an offset pivot axis 82 to increase or decrease the tension within the chain 44a.

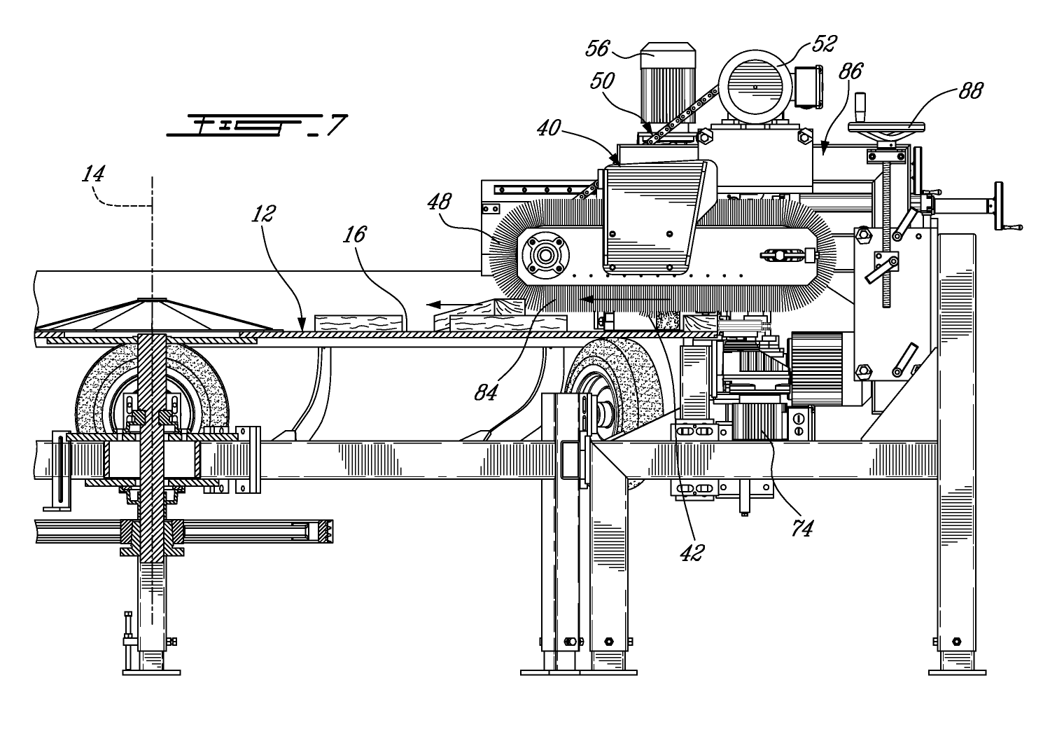

Referring now to FIG. 7, the action of a pile breaker 40 is depicted. The lower portion 84 of the conveyor brush 48 is spaced from the rotary disc 12 by only slightly more than the thickness of a wood board piece. Therefore, when two or more wood board pieces are superposed, the superposed wood board piece is frictionally engaged by the conveyor brush 48 as the stack is displaced by the rotary disc 12. The bristles of the conveyor brush 48 generate a frictional force on the superposed wood board piece which moves the superposed wood board piece back toward the center, or rotation axis 14, of the rotary disc 12. If a wood board piece standing on its edge, or side, engages the conveyor brush 48, it will typically be tipped over by the conveyor brush 48 so as to lay flat against the upper surface 16 of the disc 12.

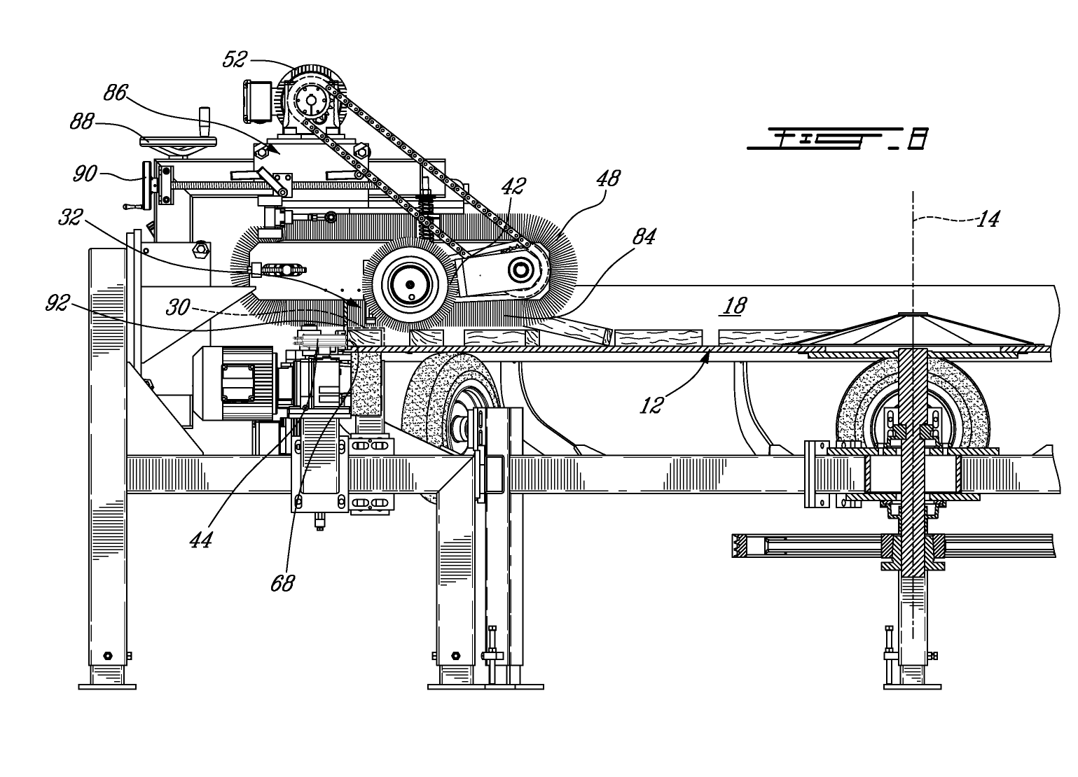

Referring also to FIG. 8, the conveyor brush 48 and the round brush 42 are both mounted to a common displaceable frame portion 86 and can be moved together vertically by using a height adjuster 88 and horizontally using a depth adjuster 90. The space defined between the lower portion 84 of the conveyor brush and the disc 12 can thus be adjusted to adapt to different thicknesses of wood board pieces to be aligned, or for fine tuning, for example.

The function of the round brush 42 is to displace wood board pieces which are laying flat on the disc 12 upper surface but which laterally abut against another wood board piece. Its function is also to displace pieces, that are not longitudinally aligned against the peripheral wall 18, out from the output path 30, and toward the center of the disc 12. The round brush 42 is thus adjacent the output path 30 and vertically spaced from the rotary disc 12 by less than the thickness of a wood board piece so as to frictionally engage wood board pieces which pass underneath it. The round brush 42 is positioned as close as possible to the peripheral wall 18 while maintaining a space set so that correctly aligned wood board pieces can still pass by it substantially unaffected. Correctly aligned wood board pieces which are carried by the disc 12 in longitudinal alignment against the peripheral wall 18 along the output path 30 thus pass in the space defined between the peripheral wall 18 and the round brush 42, and remain substantially unaffected by the round brush 42. Wood board pieces which are not confined within this space are engaged by the round brush 42. The round brush 42 frictionally engages the upper portion of such wood board pieces, which generates a frictional force oriented toward the center of the disc 12. Because of the shape of the round brush 42, the greatest frictional forces are exerted when wood board pieces are positioned directly below the rotation axis thereof. Some wood board pieces which have a relatively low degree of misalignment, or on which forces are exerted by adjacent wood board pieces, may remain substantially unaffected by the round brush 42 when they first pass by it.

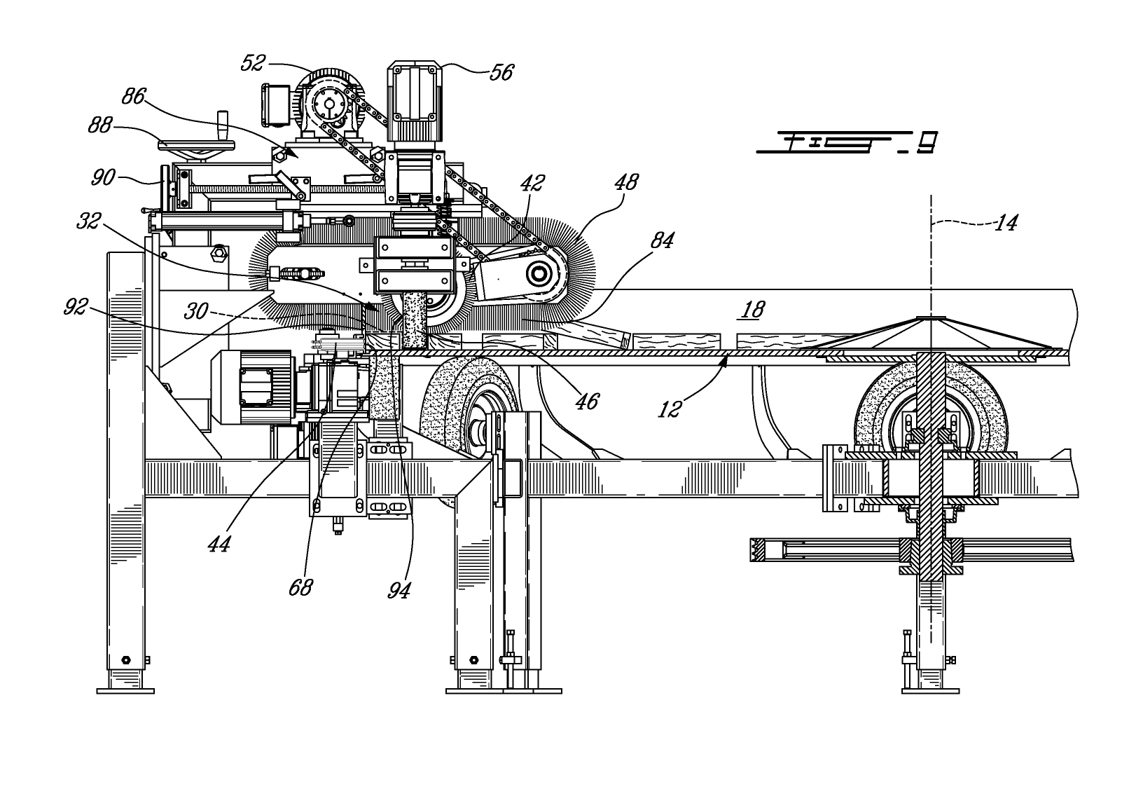

FIG. 9 shows that the lateral conveyor 44 has a radially inner portion 68 which can be slightly recessed relative to an aperture 92 defined in the peripheral wall 18. The aperture 92 is at least as wide as the thickness of the wood board pieces, so as to allow misaligned wood board pieces to contact the lateral conveyor 44. The inner portion 68 is driven in a direction opposite the output path of wood board pieces. The roller 46 also has an output path side, or radially-outer side 94, which is also driven in a direction opposite the output path. The vertically extending roller 46 is spaced from the peripheral wall 18 just enough to allow correctly aligned wood board pieces to pass between the lateral conveyor 44 and the roller 46 substantially unaffected. Hence, although the lateral conveyor 44 and the vertical roller 46 are driven in a direction which is opposite the displacement of correctly aligned wood board pieces, correctly aligned wood board pieces pass between the lateral conveyor 44 and the vertical roller 46 and are substantially unaffected by these components. The vertically extending roller 46 is said to be on a radially inner side of the output 32 whereas the lateral conveyor 44 can be said to be on a radially outer side of the output 32, relative to the rotation axis 14 of the rotary disc 12.

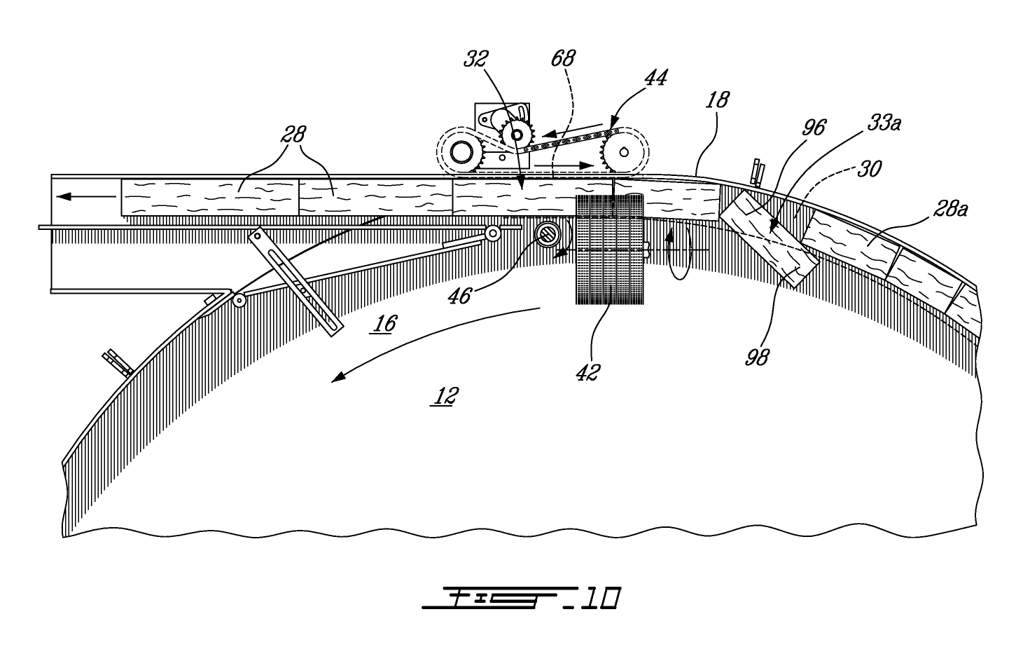

In use, misaligned wood board pieces 33 can come into contact with the roller 46 and lateral conveyor 44 as shown in FIGS. 10 through 13. The leading end 96 of a misaligned wood board piece 33a will come into engagement with the inner portion 68 of the lateral conveyor 44 and the side of the misaligned wood board piece 33a will come into engagement with the roller 46. The lateral conveyor 44 generates a pivoting force on the leading end 96 of the misaligned wood board piece 33a and the roller 46 acts as a fulcrum for the pivoting force created by the lateral conveyor 44. The combined action of the lateral conveyor 44 and the roller 46 moves the misaligned article 33a around the roller 46 and toward the center of the disc 12. At one point, in the illustrated embodiment, the misaligned article 33a will have a portion passing under the round brush 42. The round brush 42 further assists in bringing the misaligned article 33a back to the article receiving area.

Beginning with FIG. 10, the substantially tangential output path 30 is schematically depicted as having the width of a correctly aligned wood board piece 28 and being positioned immediately inward of the peripheral wall 18. The wood board pieces 28 which are correctly aligned in the output path 30 are those which longitudinally abut the peripheral wall 18 due to the centrifugal action of the rotating disc. Such articles traveling along the output path 30 are referred to as correctly aligned articles when they lay flat therein. A single file, or row, of correctly aligned articles 28 exits the disc singulator through the output 32. In this example, a single layer of articles approaches the output 32 because superposed articles were previously moved back toward the center of the rotary table by the brush conveyors. The misaligned article 33a has a leading edge 96 which abuts against the peripheral wall 18 and a side which abuts against a correctly aligned article 28a (FIG. 10).

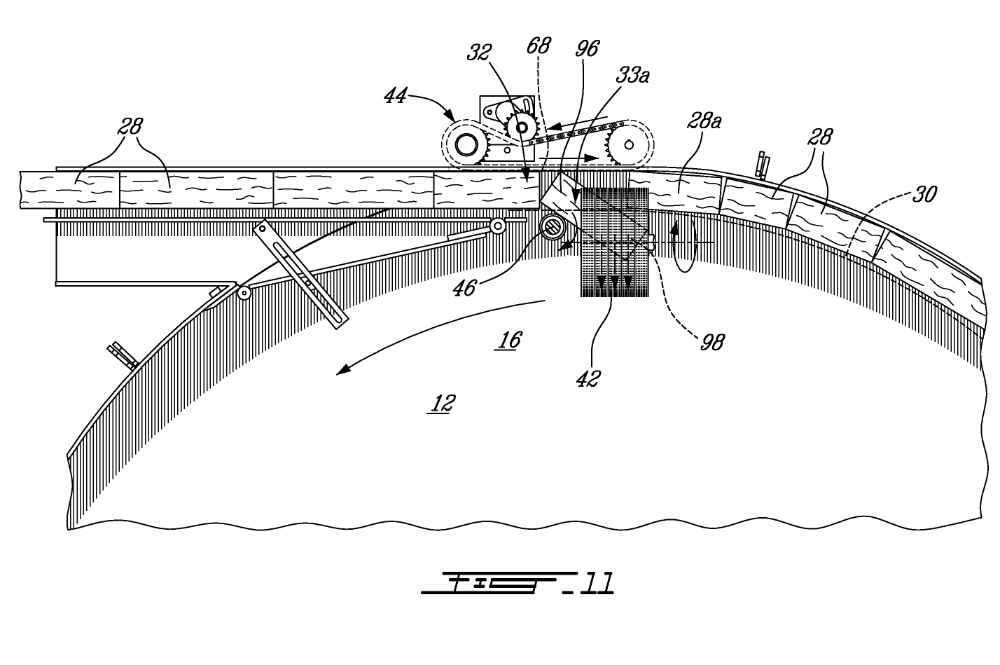

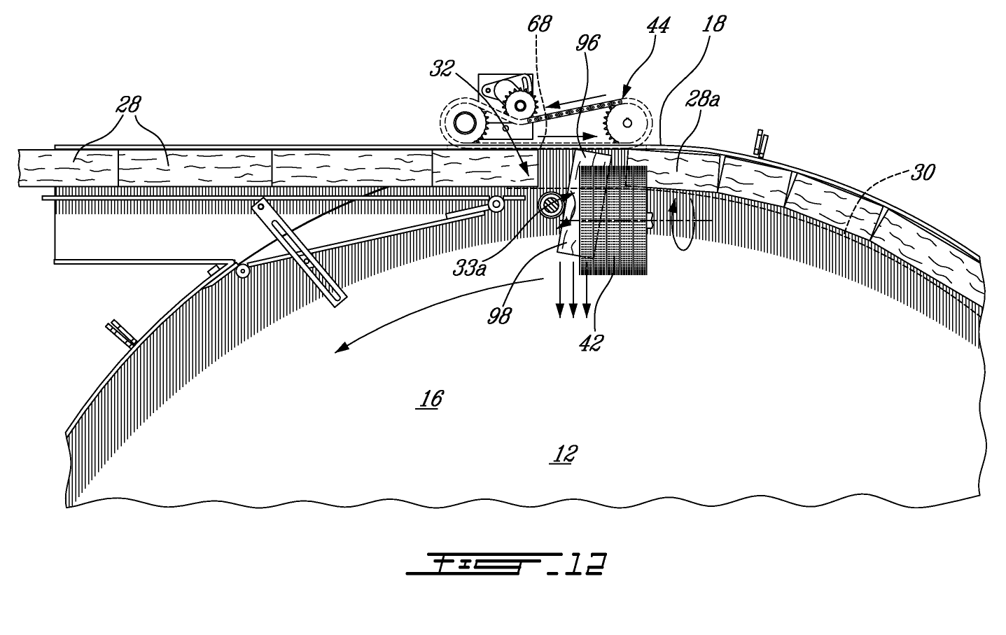

When the misaligned article engages the output (FIG. 11), the leading end 96 of the misaligned article 33a engages the inner portion 68 of the lateral conveyor 44. The lateral conveyor 44 generates a pivoting force to the leading end 96 of the misaligned wood board piece 33a and tends to move the trailing end 98 of the wood board piece 33a into fuller engagement with the round brush 42. This pivoting movement is assisted by the roller 46, which is engaged by a side of the misaligned wood board piece 33a. Hence, the leading edge 96 of the wood board piece 33a is displaced in the direction opposite to the output path 30 by the lateral conveyor 44 and is thus pivoted around the roller 46. This causes the trailing end 98 of the misaligned article 33a to increasingly engage the rotary brush 42 (FIGS. 11 and 12).

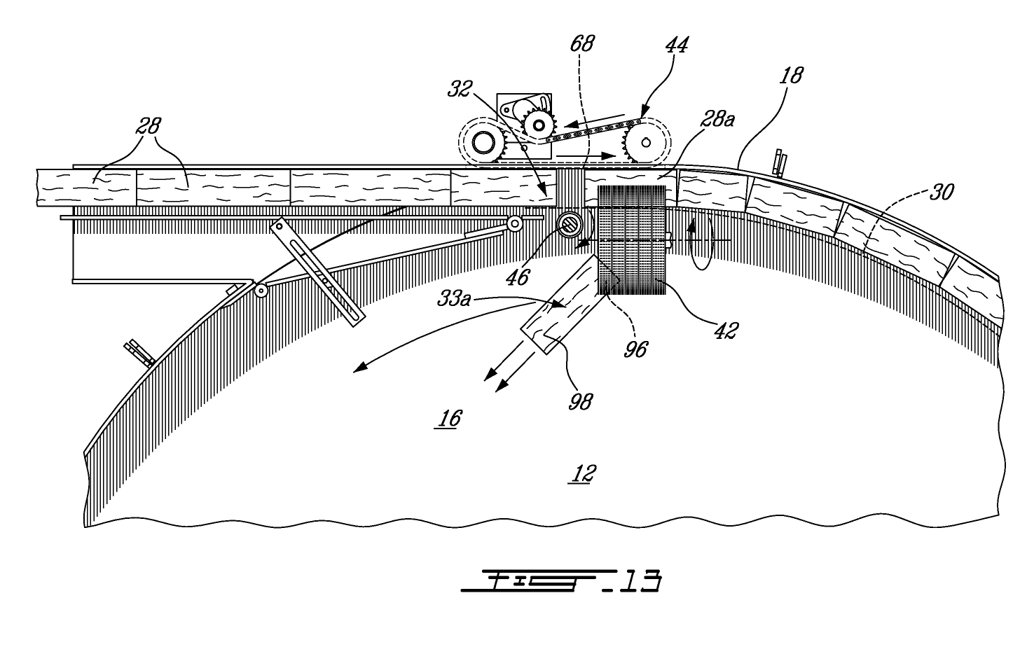

The misaligned wood board piece 33a is eventually moved out from the output 32 by the combined action of the round brush 42, the rotating roller 46 and also by the rotary disc 12. FIG. 13 shows the misaligned wood board piece being moved out from the output and back to the article receiving area of the rotary disc. The following correctly aligned article 28a can then engage the output 32. The correctly aligned article 28a remains substantially unaffected by the round brush 42, the lateral conveyor 44 and the roller 46.

The method of disengagement proposed herein thus includes moving the leading end of the misaligned article in a direction opposite the output path, along a radially-outer side of the output, and thereby pivoting the misaligned article around a vertically extending fulcrum positioned at a radially inner side of the output.

For illustrative purposes, in the example given above, the rotary disc 12 can have a diameter of about 10 feet and operate at angular speeds in the order of 50 RPM. The wood board pieces to be aligned can be trims from standard lengths 2×4 wood boards between 0.5 and 3 feet in length. The endless chain can have a height (or width) of 1½ inches for use with such wood board pieces. If larger wood board pieces are used, such as trims from 6×6 boards, the width of the endless chain can be increased.

An advantage of the illustrated embodiment is that it has less risks of stopping, in the sense that when the disc singulator is in operation, all of the rotary disc, the brush conveyors, the round brush, the roller, and the endless chain can be continuously driven without interruption.

Having discussed above an example of an improved disc singulator with the misaligned article disengagement system, it will now be discussed some alternate configurations. First, it should be noted that although the articles to align are wood board pieces in the example given above, the present improvements can be adapted for use with other types of elongated articles than wood board pieces.

The lateral conveyor can be used with a rubber belt or another kind of flexible member.

The lateral conveyor can be positioned in alignment with the peripheral wall, but can also be slightly recessed within the aperture in the peripheral wall. A recessed configuration can be used, for instance, in cases where correctly aligned articles otherwise have a tendency to engage and be disturbed by the lateral conveyor.

The fulcrum member can be fixed instead of being driven by a motor. It can also be rotatable without being motor driven.

The round brush can be entirely omitted or replaced with an equivalent displacement device, such as a rubber flap rotor for example. As discussed, if very long elongated articles are to be aligned by the disc singulator, the trailing end portion of these articles may sufficiently extend toward the rotation axis of the rotary disc to offer a sufficient lever arm for the frictional force exerted on the trailing end of the article by rotary disc to pivot the misaligned article around the fulcrum member without the aid of a displacement device.

The improved misaligned article disengagement system can be sold in combination with a new disc singulator, but it can also be provided alone, as a retro-fit system for existing centrifugal disc singulators.

As can be seen therefore, the examples described above and illustrated are intended to be exemplary only. The scope of the invention(s) is intended to be determined solely by the appended claims.

What is claimed is:

1. A misaligned article disengagement system for use at an output of a centrifugal disc singulator in which elongated articles exit lengthwise following a substantially tangential output path at a periphery of a rotary disc, the rotary disc having a vertical rotation axis and an upper article-receiving area surrounded by a peripheral wall, the disengagement system comprising:
a lateral conveyor positioned at a radially-outer side of the output, the lateral conveyor having an inner portion extending substantially parallel to the output path and movable in a direction opposite the output path; and
a vertically-extending fulcrum member positioned at a radially-inner side of the output and being adjacent to the inner portion of the lateral conveyor;
whereby, in use, a misaligned article is moved out of the output and back to the article-receiving area of the singulator when a leading end of the misaligned article engages the inner portion of the lateral conveyor and a side of the misaligned article engages the fulcrum member.

2. The system of claim 1 further comprising an article displacement device positioned immediately upstream of the fulcrum member at a radially-inner side of the output path and operable to frictionally engage an upper surface of the misaligned article and assist it as it moves out of the output toward the article receiving area.

3. The system of claim 2 wherein the article displacement device includes a round brush having a substantially horizontal rotation axis.

4. The system of claim 1 wherein the lateral conveyor includes an endless chain.

5. The system of claim 4 wherein the inner portion of the endless chain is in a sliding engagement with a backing plate.

6. The system of claim 1 wherein the fulcrum member includes a roller journaled around a vertically extending spindle.

7. The system of claim 6 wherein the roller is driven into rotation by a motorized arrangement, the roller being driven in a direction to move the misaligned article out of the output.

8. The system of claim 1 further comprising a brush conveyor located upstream the output and vertically spaced from the rotary disc by at least the height of the output path.

9. The system of claim 1 wherein the elongated articles include wood board pieces.

10. A centrifugal disc singulator comprising: a rotary disc having a vertical rotation axis and defining an upper article-receiving area surrounded by a peripheral wall and an output in which elongated articles exit lengthwise following a substantially tangential output path at a periphery of the rotary disc, a lateral conveyor positioned at a radially-outer side of the output, the lateral conveyor having an inner portion extending substantially parallel to the output path and movable in a direction opposite the output path, and a vertically-extending fulcrum member positioned at a radially-inner side of the output and being adjacent to the inner portion of the lateral conveyor.

11. The system of claim 10 further comprising an article displacement device positioned immediately upstream of the fulcrum member at a radially-inner side of the output path and operable to frictionally engage an upper surface of the misaligned article and assist it as it moves out of the output toward the article receiving area.

12. The system of claim 11 wherein the article displacement device includes a round brush having a substantially horizontal rotation axis.

13. The system of claim 10 wherein the fulcrum member includes a roller journaled around a vertically extending spindle.

14. The system of claim 13 wherein the roller is driven into rotation by a motorized arrangement, the roller being driven in a direction to move the misaligned article out of the output.

15. The system of claim 10 further comprising a brush conveyor located upstream the output and vertically spaced from the rotary disc by at least the height of the output path.

16. The system of claim 10 wherein the elongated articles include wood board pieces.

17. A method of disengaging a misaligned article entering an output of a centrifugal disc singulator having an upper article-receiving area, the method comprising:
moving a leading end of a misaligned article abutting a radially-outer side of the output, the leading end being moved in a direction opposite an output path; and
supporting the side of the misaligned article along a vertically extending fulcrum member positioned at a radially-inner side of the output until the misaligned article goes back into the article-receiving area.

18. The method of claim 17 further comprising driving the fulcrum member into rotation to assist the misaligned article moving back to the article-receiving area.

19. The method of claim 17 further comprising frictionally engaging an upper surface of the misaligned article to displace the misaligned article back to the article-receiving area.

20. The method of claim 17 further comprising moving superposed articles toward a rotation axis of the rotary disc.
